(19) United States
(12) Patent Application Publication
(10) Pub. No.: US 2012/0158839 A1
(43) Pub. Date: Jun. 21, 2012

(54) WIRELESS NETWORK INTERFACE WITH INFRASTRUCTURE AND DIRECT MODES

(75) Inventors: AMER A. HASSAN, Kirkland, WA (US); Mitesh K. Desai, Redmond, WA (US); Mukund Sankaranarayan, Sammamish, WA (US); Henrique Filgueiras, Kirkland, WA (US); Mark Clear, Monroe, WA (US)

(73) Assignee: Microsoft Corporation, Redmond, WA (US)

(21) Appl. No.: 12/970,034

(22) Filed: Dec. 16, 2010

(51) Int. Cl. G06F 15/16

(52) U.S. Cl. 709/204

(57) ABSTRACT

An architecture for a computing device to enable the computing device to support peer-to-peer communications using a wireless radio also configured for infrastructure-based communication. The architecture includes a driver for the wireless radio that supports ports for communication in accordance with the peer-to-peer protocol. A port may act as a control port through which action frames that control the formation of a peer-to-peer group may be sent and received. One or more other ports may be used for exchanging data with other devices in the group. Each of these ports may be configured in accordance with its role in the group, such that each port may be configured for operation as a group owner or a client. Additionally, after establishing a group, the control port may be used as a side channel for controlling a device in a group associated with another port.

### BACKGROUND

Many computers today have radios to support wireless communication. Wireless communication is used, for example, to connect to an access point of a network. By associating with the access point, a wireless computer can access devices on the network or to other networks reachable through that network, such as the Internet. As a result, the wireless computer can exchange data with many other devices, enabling many useful functions.

To enable computers to be configured for association with an access point, it is common for the access points to operate according to a standard. A common standard for devices that connect to access points is called WI-FI. This standard was promulgated by the WI-FI Alliance, and is widely used in portable computers. There are multiple versions of this standard, but any of them can be used to support connections through access points.

Wireless communications may also be used to form connections directly to other devices without using an access point. These connections are sometimes called “peer-to-peer” connections and may be used, for example, to allow a computer to connect to a mouse or keyboard wirelessly. Wireless communications for these direct connections also have been standardized. A common standard for such wireless communications is called BLUETOOTH®.

In some instances, a wireless computer may concurrently connect to other devices through an access point and as part of a group engaging in peer-to-peer communications. To support such concurrent communication, some computers have multiple radios. More recently a standard has been proposed, called WI-FI Direct, that enables both an infrastructure connection and communication as part of a peer-to-peer group with similar wireless communications that can be processed with a single radio. This standard, also published by the WI-FI Alliance, extends the popular WI-FI communications standard for infrastructure-based communications to support direct connections.

Equipping computing devices to support direct connections is expected to expand the scenarios in which a wireless computing device can connect to other wireless devices. For example, computer users working together may more readily form a group that allows the users to share data without requiring any specific infrastructure. Similarly, a computer may more readily connect wirelessly to a printer or devices providing other desired services.

### SUMMARY

A wireless computing device may be simply implemented and simply controlled to support both wireless communications in an infrastructure mode and in a peer-to-peer mode by providing a radio driver that supports configurable ports. The ports may be dynamically configured ports for operation in infrastructure mode. Alternatively or additionally, ports may be configured to support peer-to-peer communication.

Ports supporting peer-to-peer communication may include a control port and one or more communication ports. The control port may be used to send and receive control frames, such as public action frames and service discovery frames. Exchanges of these control frames may be conducted under control of an operating system and may result in the driver establishing a group of devices, including the wireless computing device, for peer-to-peer communication. As part of establishing a group, a role of the wireless computing device within the group may be negotiated with other devices in the group. The control port may support sending and receiving control frames to perform these functions.

Once a group has been established, a second port configured for communication among the devices in the group may be used. That port may be configured based on the role negotiated for the wireless computing device. The device, for example, may operate as a group owner or a client in the peer-to-peer group.

The driver may support multiple peer-to-peer communication ports such that the wireless computing device may be configured to be a client in some groups and a group owner in other groups. Each port may be configured to support communication among devices in one or more groups. As a result, the wireless computing device may participate in multiple groups with the same or different roles in each group.

Moreover, one or more ports may be configured for communication in infrastructure mode. As a result, the wireless computing device can, in addition to supporting concurrent communication with multiple groups, support concurrent communication in an infrastructure mode and a peer-to-peer mode, allowing the device to be flexibly configured for many scenarios.

Further, though a port may be configured for a designated function, a port may be used for other functions when such functions are not inconsistent. As one example, a control port, configured to send and receive frames used in establishing a peer-to-peer group, may be used after establishing such a group as a side channel for controlling one or more devices in the group. Commands to control the device may be sent separately from data frames over a connection to that device. As a specific example, the control port may be used to establish a group containing the computing device and a display device, such as a television equipped with a wireless network connection. Once the connection is established, the computing device may send commands through the control port to control the audio/video characteristics of the display device. In this way, the computing device can stream audio/video content as data through a port configured for peer-to-peer communication with the display device and separately act as a remote control from the computing device to change audible characteristics and/or visual characteristics of the display.

Despite the flexibility in modes of communication and combinations of modes supported, the wireless computing device may be simply controlled through a relatively small number of commands.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a sketch of an exemplary environment in which embodiments of the invention may be practiced;

FIG. 2 is a high level block diagram of an exemplary computing device adapted for wireless communication;

FIG. 3 is a more detailed block diagram of an exemplary computing device adapted for wireless communications;

FIG. 4 is a flowchart of an exemplary process of establishing a control port for peer-to-peer wireless communication;

FIG. 5 is a flowchart of an exemplary process of establishing a peer-to-peer connection according to some embodiments;

FIG. 6 is a flowchart of an exemplary process of sending or receiving data frames over a peer-to-peer wireless connection;

FIG. 7 is a flowchart of an exemplary process of transmitting data frames while using a control port to implement a side channel;

FIG. 8 is a sketch illustrating an exemplary environment in which side channel communications may be used; and

FIG. 9 is a sketch of a computing device illustrating an exemplary environment in which embodiments of the invention may be practiced.

### DETAILED DESCRIPTION

The Inventors have recognized and appreciated that a simple, yet flexible, control mechanism to support direct communication with devices in a peer-to peer group as well as communication in an infrastructure mode would greatly expand the usability and availability of direct communication. Such a capability may expand the prevalence of computing devices that support direct mode communications in addition to traditional infrastructure-mode communication. Moreover, by providing concurrent control of the same radio, the cost of separate radios to support multiple modes of communication may be avoided.

In accordance with some embodiments, such functionality may be implemented within a driver for a radio in a wireless computing device. The radio may be capable of recognizing multiple Media Access Control (MAC) addresses. The driver may interact with the radio to implement multiple ports, each associated with a MAC address used by the radio. Each port may be configured to operate in either infrastructure mode or in a mode for direct communications with a peer-to-peer group of devices.

Of the ports configured for direct communications with a peer-to-peer group of devices, one such port may be configured as a control port. The control port may be used to send and receive control frames that establish a direct connection with a group of devices. Communications through the control port may also establish a role of the wireless computing device within the group.

One or more other ports may be used to support direct communications with a peer-to-peer group of devices. These ports may be configured to support a specific role for the wireless computing device within the group. Such a port may be configured, for example, to support a role as a group owner or a client. In this way, the wireless computing device can participate in group owner negotiation in accordance with the WI-FI Direct standard, and, regardless of the results of the negotiation, operate in its negotiated role.

Configuration of each port may be based on activating software within the driver containing instructions for sending and receiving frames appropriate for the configuration of the port. Though, processing of frames may be split between the driver and the operating system such that the operating system retains state information about communications through the port. Accordingly, the driver may respond to frames that do not require state information, such as by issuing an acknowledgement in response to a received message. Other frames may be passed to the operating system.

Interactions between the operating system and the driver may be through a standard driver interface. Such an interface may support a set of commands, called OIDS in some implementations. A small number of additional commands may be used to support configuration of a driver to provide ports for direct communication between wireless devices in a group. The additional commands may control the driver to configure a port to act as a control port or to take on one of the roles in a group. Commands may also allow the operating system to command the driver to perform functions as appropriate for its assigned role. For example, when configured as a control port, the port may be commanded to discover devices and services, exchange frames with other devices to form a group, and to negotiate a role for the wireless computing device within the group.

In some embodiments, the driver may be configured to recognize additional commands, including commands that cause side channel transmissions that are not related to either establishing or communicating over an infrastructure connection or a peer-to-peer connection. As one example, a driver may be configured to send frames that may be recognized as controlling some aspect of a device in a peer-to-peer group that is not directly related to a peer-to-peer connection.

As a more specific example, a direct connection in a wireless computing device may be used to send audio/video information from a computing device to a nearby display device. Such audio/video content may be audio information, such as music, and the display device may be stereo speakers. The side channel information may be used to control the volume, tone or other audio characteristic of the music played through the speakers. Alternatively, the audio/video content may be a picture and the display device may be a projector. The side channel information may be used to control the brightness or other video characteristic of the picture presented by the projector. As yet another example, the audio/video content may be a movie, and the display device may be a television. The side channel information may be used to control the brightness or other video characteristic of the movie and the volume or other audio characteristic of the movie played on the television.

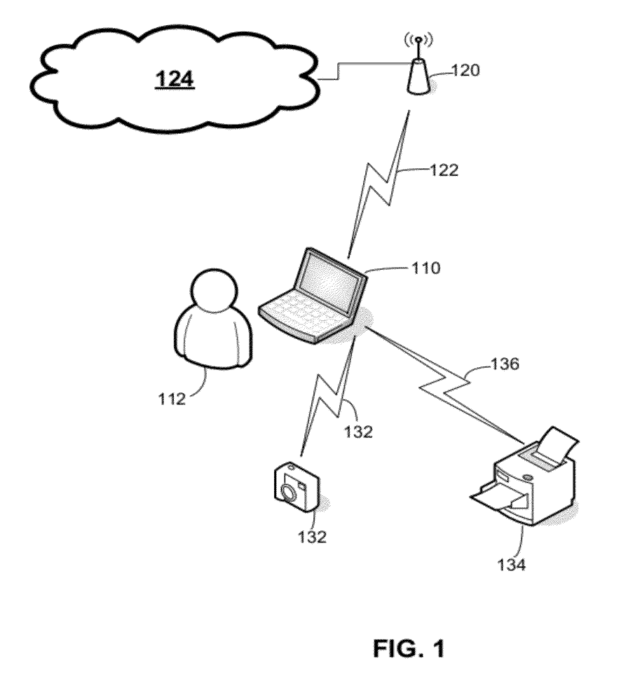

The forgoing communication techniques may be used alone or together in any suitable combination in any suitable environment. FIG. 1 illustrates an environment in which a computing device communicates according to some embodiments.

In the example of FIG. 1, computing device 110 is illustrated as a laptop computer. Though, it should be appreciated that the form factor of computing device 110 is not a limitation on the invention. Computing devices configured as tablets, Smart Phones or with any other suitable form factor may be configured and operated according to embodiments of the invention.

FIG. 1 illustrates that computing device 110 is being controlled by user 112. User 112 may interact with computing device 110 using techniques as are known in the art to control computing device 110 to wirelessly connect with other devices. In this example, computing device 110 has a wireless connection through access point 120 to network 124. Network 124 may be a home network, an enterprise network, the Internet or any other suitable network. Wireless connection 122 through access point 120 is an example of an infrastructure type connection. Any suitable technique may be used to form wireless connection 122, including techniques that employ known infrastructure type protocols. As one example, wireless connection 122 may be formed using a protocol sometimes called “WI-FI”. Though, the specific protocol used is not critical to the invention.

In the example illustrated, computing device 110 has the role of a station in wireless connection 122. The role of the computing device 110 indicates the specific steps of the wireless protocol performed by computing device 110 in order to exchange information with access point 120.

FIG. 1 also illustrates other wireless connections. Computing device 110 is shown to have connections 132 and 136 to camera 130 and printer 134, respectively. In this case, camera 130 and printer 134 are examples of wireless devices with which computing device 110 may connect in order to exchange data with these devices.

In this example, camera 130, printer 134 and computing device 110 may communicate over wireless connections 132 and 136 using a peer-to-peer protocol. In this example, camera 130, printer 134 and computing device 110 may form a group according to a peer-to-peer protocol. Though, in alternative embodiments, computing device 110 may form a first group with camera 130 and a second group with printer 134.

Wireless connections 132 and 136 may be formed according to any suitable peer-to-peer protocol. In this example, connections 132 and 136 are formed using an extension of the WI-FI protocol, referred to as WI-FI Direct.

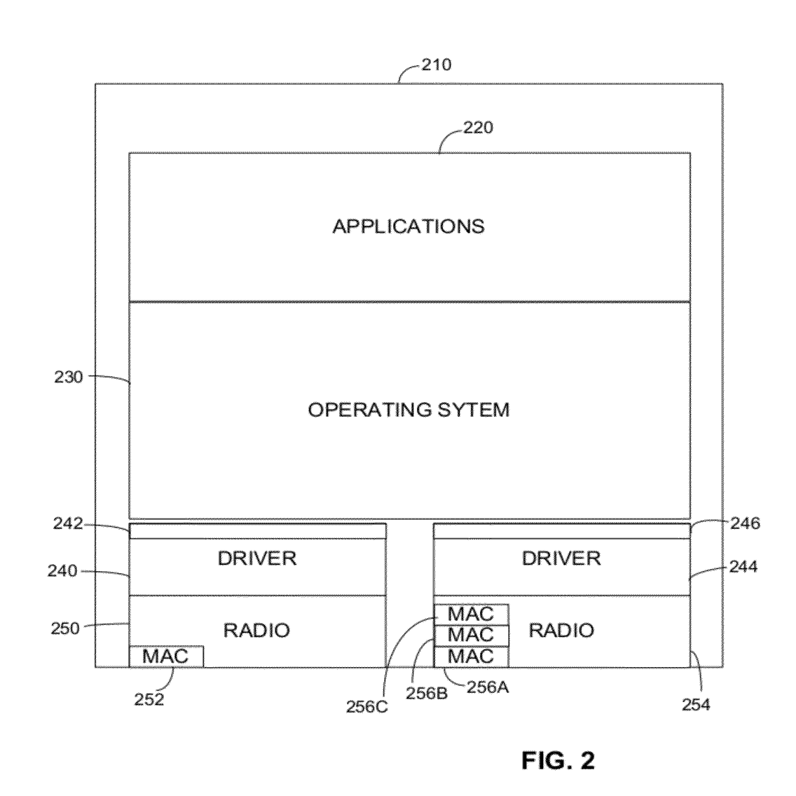

FIG. 2 illustrates, at a high level, an architecture for computing device 210 that may be operated to form an infrastructure mode wireless connection, such as wireless connection 122 (FIG. 1) and peer-to-peer wireless connections, such as connections 132 and 136 (FIG. 1). In the example of FIG. 1, computing device 210 includes two radios, radio 250 and radio 254. Each of the radios may be adapted to send and receive wireless communications. Radio 250, for example, may be used to form wireless connection 122. Radio 254, for example, may be used to form peer-to-peer connections 132 and 136.

In this example, radio 250 has a media access control (MAC) address 252. The MAC address may be a unique identifier associated with radio 252 such that it may be used to distinguish radio 252 from radio 254 and also from radios in any other devices with which computing device 210 may communicate. Accordingly, the MAC address 252 may be included in packets sent by radio 250 to indicate that the frame was sent by radio 250 or may be included in packets directed to radio 250 to indicate that a frame is intended for radio 250.

MAC address 252 may be assigned to radio 250 in any suitable way. It maybe assigned, for example, by the manufacturer or radio 250. Though, in some embodiments, MAC address 252 may be assigned by operating system 230 or another component of computing device 210 or by some other component in a system in which computing device 210 is operating.

Radio 250 may be controlled through software, represented as driver 240 in FIG. 2. Here, driver 240 includes an interface 242 through which operating system 230 may issue commands to driver 240 and through which driver 240 may report status and notify operating system 230 of received data. Interface 242 may be implemented in any suitable way, including according to a known standard. An example of such a known standard is called NDIS, but that standard is not critical to the invention.

Interface 242 may support a number of commands in a format that does not depend on the construction of radio 250. Rather, driver 240 may translate the commands, in the standardized format of interface 242, into specific control signals that are applied to radio 250. Additionally, driver 240 may be programmed to perform certain low level functions associated with a wireless connection. For example, upon receipt of a packet, driver 240 may check that the packet is properly formatted. If the packet is properly formatted, driver 240 may control radio 250 to generate an acknowledgement. Conversely, if the packet is not properly formatted, driver 240 may control radio 250 to transmit a negative acknowledgement.

Though driver 240, and in some instances radio 250, may automatically perform low level functions associated with establishing and maintaining a wireless connection, higher level functions may be performed under control of operating system 230 or applications 220. In some embodiments, an application 220 or operating system 230 may provide a user interface such that ultimate control of wireless communication is provided by a user of computing device 210.

In the embodiment illustrated in FIG. 2, computing device 210 also includes a radio 254. While radio 250 may be used, for example, for a connection to an infrastructure network, radio 254 may be used to form one or more peer-to-peer connections, such as connections 132 and 136.

Radio 254 is incorporated into computing device 210 with generally the same architecture as radio 250. Radio 254 is associated with a driver 244 that provides a mechanism for operating system 230 to control radio 254. Driver 244 has an interface 246 through which operating system 230 may send commands to driver 244 and driver 244 may provide status to operating system 230. Interface 246, like interface 244, maybe a standardized interface such that operating system 230 may communicate with driver 244 using a similar set of commands as are used to control driver 240. Though, because radio 254 is used to implement peer-to-peer connections, driver 244 may respond to different or additional commands than driver 240 in order to implement functions associated with peer-to-peer communications that do not exist for infrastructure based communications.

As an additional difference between radios 250 and 254, radio 254 is illustrated as having multiple MAC addresses. In contrast, radio 250 includes a single MAC address 252. Here, MAC addresses 256A, 256B and 256C are illustrated. Multiple MAC addresses may, for example, be assigned by a manufacturer of radio 254 or the MAC addresses may be assigned in any suitable way, including as described above in connection MAC address 252.

Having multiple MAC addresses allows radio 254 to appear to devices external to computing device 210 as multiple entities, each with a separate MAC address. As an example, if computing device 210 is separately communicating as a group owner in a first peer-to-peer group and as a client in a second peer-to-peer group, separate entities may be established for the group owner and the client. Devices external to computing device 210 may address packets intended to be processed by computing device 210 as a group owner in the first group with a first MAC address. Packets intended to be processed as a client in the second group may be addressed with a second MAC address. Similarly, computing device 210 may insert the first MAC address in packets coming from the group owner, the first MAC address; packets from the client may include the second MAC address.

To allow operating system 230 to associate its interactions with driver 244 with a specific one of those entities, internal to computing device 210, each of the entities may be represented as a port. Accordingly, operating system 230 may send commands to or receive status information from each such entity through a port associated with that entity.

Each of the ports may be configured to perform functions appropriate for the type of entity the port represents. As an example, a device that is part of a peer-to-peer group may take on a role of a group owner or a client. A group owner may be required in accordance with a wireless protocol to send certain types of action frames and respond to other types of action frames in specified ways. A device configured as a client may send different action frames and responses or may send the same action frames and responses in different contexts.

Though, it should be appreciated that a group owner and a client are just two examples of the roles that radio 254 and driver 244 may be configured to perform. As another example, an entity may be configured as neither a group owner nor a client. Rather, an entity may be assigned a role as a controller that manages interactions with other devices to form a group and determine the role of computing device 210 in that group.

Though FIG. 2 illustrates separate radios, radio 250 and radio 254, in embodiments in which infrastructure connections and peer-to-peer communications operate using the same frequency channels, a single radio may be used. In such an embodiment, entities performing roles associated with infrastructure communication and entities performing roles associated with peer-to-peer communications may be implemented with the same radio.

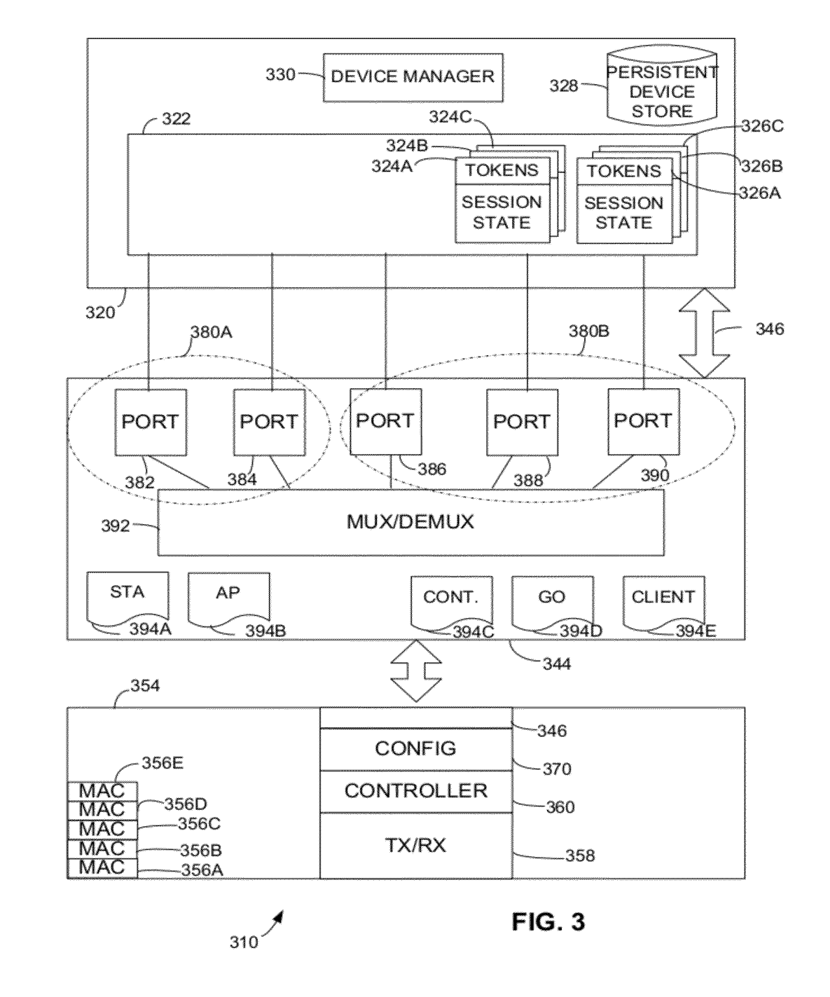

FIG. 3 illustrates an embodiment in which a computing device 310 is configured to support entities that each has a role in an infrastructure network and entities that each has a role for peer-to-peer communication using a single radio. FIG. 3 illustrates computing device 310 containing a radio 354. Radio 354 is illustrated as having multiple MAC addresses, illustrated as MAC addresses 356A, 356B, 356C, 356D and 356E. Though five MAC addresses are illustrated, which may allow radio 354 and its associated driver 344, to concurrently provide five ports, it should be appreciated that the specific number of MAC addresses supported is not critical to the invention and more or less than five MAC addresses may be used in some embodiments.

In this example, the five MAC addresses may be used to provide five ports 382, 384, 386, 388 and 390 each configured to perform a different role. In the scenario illustrated, a group 380A of these ports has been configured to implement entities used for infrastructure based communications. Group 380B contains ports configured for peer-to-peer communications.

In the example illustrated in FIG. 3, group 380A contains two ports, ports 382 and 384. Group 380B is shown containing three ports, ports 386, 388 and 390. It should be appreciated the number of ports allocated for each type of use is not critical to the invention and any suitable number may be used. Moreover, it is not a requirement that the number of ports in each group remain static. Rather, operating system 320 may issue commands to driver 344 to dynamically create or break down ports as needed.

In conjunction with a command to create a port, operating system 320 may specify a role associated with that port. Driver 344 may respond to such a command by creating a port configured for a designated role, which may be associated with infrastructure-based communications or with peer-to-peer communications.

Though any suitable mechanism may be used to implement such a capability, FIG. 3 illustrates an interface 346 between operating system 320 and driver 344. Interface 346 may be an interface to a driver in a standardized format. As one example, some drivers are written in accordance with the NDIS interface specification. In accordance with that specification, commands and status information may be exchanged between driver 344 and operating system 320 using programming objects called OIDs. The NDIS standard defines a number of OIDs that drivers should or may respond to. The standard, though, is extensible such that OIDs may be defined to support additional functionality in certain circumstances. This extensibility may be used to define commands, using OIDs or other suitable representation, that allows operating system 320 to command driver 344 to create or break down a port or to configure a port for a specific role.

Though radio 354 can process packets for multiple ports, other than supporting multiple MAC addresses, radio 354, in some embodiments, need not be specially configured for supporting ports. Radio 354 may be implemented using techniques as are known in the art. In this example, transmitter/receiver section 358 may be a hardware component as is known in the art and used for wireless communications. In this example in which radio 354 is being used to support communications in accordance with the WI-FI infrastructure-mode protocol and the WI-FI direct protocol for peer-to-peer communications, transmitter/receiver section 358 may support communications in multiple subchannels over a frequency range defined by the WI-FI specification. Though, the specific operating characteristics of transmitter/receiver section 358 may vary depending on the specific protocol implemented for communication and are not critical to the invention. Likewise, controller 360 may be a hardware component as is known in the art of wireless radio design. Similarly, configuration register 370 may be a hardware component as is known in the art of wireless radio design. The components indicated as MAC address 356A . . . 356E may also be implemented using techniques as are known in the art. In some embodiments, the MAC addresses supported by radio 354 may be encoded in a read only memory or other component that is a portion of radio 354. Though, it should be appreciated that, in embodiments in which MAC addresses are assigned to radio 354 through driver 344, MAC addresses 356A . . . 356E may be physically implemented in either volatile or non-volatile rewriteable memory such that the pool of MAC addresses to which radio 354 can respond may be dynamically created.

Regardless of the manner in which the components of radio 354 are implemented, radio 354 may contain a hardware interface 346 through which driver 344 may control radio 354. In some embodiments, driver 344 may be computer executable software instructions executing on a processor within computing device 310. Accordingly, hardware interface 346 may be implemented as a bus connection or other suitable interconnection between the processor executing driver 344 and a separate card holding radio 354. Though, such hardware interfaces are known in the art, and any suitable interface may be used.

To configure radio 354 to support a port, driver 344 may radio 354 to process packets for a specific MAC address associated with communications through that port. Driver 344 may write a value into control register 370 indicating that a MAC address should be activated such that radio 354 will process received packets identified with that MAC address. In operation, controller 360 may control transmitter/receiver section 358 to respond to any packets identified with a MAC address identified as active by information in configuration register 370. Accordingly, if multiple ports are active, configuration register 370 will contain an indication of each of the active MAC addresses.

In addition to configuring radio 354 to respond to a MAC address for a port, driver 344 may specify communications parameters to be used with that MAC Address. These parameters may specify, for example, that a different number of subchannels may be used for communication with different MAC addresses. In this way, communication characteristics with different parts may be controlled based on the role associated with the port. As a specific example, a port configured as a control port may require lower bandwidth than a port for communicating data. Accordingly, radio 354 may be configured to use fewer subchannels or a different encoding scheme for a MAC address that is associated with a control port.

For information to be transmitted, driver 344 and/or radio 354 may be operated such that any frames transmitted containing such information will be identified by the MAC address associated with the port for which the information is being transmitted. Any suitable mechanism may be used to associate MAC addresses with specific frames sent from or received for a specific port. Moreover, this processing may be performed partially or totally within driver 344 and partially or totally within radio 354 because the specific implementation does not impact functioning of the ports.

To implement multiple ports, driver 344 may also be configured. In this example, driver 344 is illustrated to contain computer executable instructions that implement a multiplexer/demultiplexer 392. Multiplexer/demultiplexer 392 operates to route received packets associated with a port to a portion of driver 344 that implements the functionality of the respective port. Conversely, multiplexer/demultiplexer 392 receives packets for transmission from any of the ports and routes those packets to radio 354.

In scenarios in which multiple ports simultaneously have information for transmission, multiplexer/demultiplexer 392 may mediate to establish the order in which radio 354 receives information from the ports. For this purpose, multiplexer/demultiplexer 392 may use any suitable policy. For example, packets carrying control frames may be given priority over packets with data frames. As another example of a policy, transmissions associated with ports operating in infrastructure mode may be given priority over ports operating in peer-to-peer mode. As yet another example, a port configured for the role of group owner may be given priority over a port configured for the role of client in a peer-to-peer group. Though, the specific policies applied by multiplexer/demultiplexer 392 are not critical to the invention, and any suitable policies may be employed.

In addition to configuring multiplexer/demultiplexer 392 to route packets, driver 344 may be configured by associating specific functional modules with each of the ports. The specific functional module associated with the port may be based on the role assigned to that port. For example, FIG. 3 illustrates five functional modules. Functional module 394A, when associated with a port, may configure that port to operate in the role of a station in an infrastructure network. Similarly, functional module 394B, when associated with a port, may configure that port for the role of an access point in an infrastructure network. Functional module 394C, when associated with a port, may configure that port for operating in the role of a controller in peer-to-peer mode. Functional module 394D, when associated with a port, may configure that port for the role of group owner in a peer-to-peer group. Functional module 394E, when associated with a port, may configure that port for the role of client in a peer-to-peer group. Other functional modules, though no illustrated in FIG. 3, may alternatively or additionally be included.

Functional modules 394A . . . 394E may be implemented in any suitable way. For example, each of the functional modules may be implemented as a collection of computer executable instructions that are encoded to perform functions for the role associated with the functional module. For example, functional module 394A may be encoded with instructions that control radio 354 to transmit packets as appropriate for a station in an infrastructure network. Additionally, functional module 394A may contain instructions that allow driver 344 to interact with operating system 320 in a way that implements the behaviors of a station in an infrastructure network. As a specific example, functional module 394A may be encoded to automatically generate responses to certain received frames. Additionally, functional module 394A may be encoded to transfer data received in a frame to a location in memory on computing device 310 and then notify operating system 320 that data has been received. Further, functional module 394A may configure radio 354 for the role of that functional module. Such configuration may include setting a number of subchannels or other parameters of the wireless communications used in the specified role. The operations performed by functional module 394 may be similar to those performed in a conventional driver for a wireless network interface card configured only as a station in a WI-FI network, and functional module 394 may be encoded using techniques are known in the art.

Each of the other functional modules may be similarly encoded to interact with the operating system 320 and radio 354 and to configure radio 354 and to internally process and generate communications as appropriate for its respective role. Functional module 394B, for example, may be encoded with computer executable instructions that perform operations on or respond to received frames with behaviors as are known in the art for an access point in an infrastructure network. Also, functional module 394B may be encoded to interact with operating system 320 using techniques as are known in the art.

Functional module 394C may be encoded to perform functions associated with establishing a peer-to-peer group. The instructions that implement functional module 394C may likewise be written using techniques that are known in the art. Those instructions may cause radio 354 to transmit packets containing action frames or responses to action frames of the type used in establishing a group for peer-to-peer communication according to a specific protocol. Components within operating system 320 may trigger the sending of those action frames. Though, for some action frames, functional module 394C may be configured to generate a response to an action frame without express action by operating system 320. Table 1 lists examples of action frames that functional module 394C may be commanded to send by operating system 320. These action frames represent action frames appropriate for a WI-FI direct protocol. Additional action frames used in that protocol may be sent without an express command in response to a received action frame or other suitable trigger. Though, it should be appreciated that different or additional action frames may be used for different protocols, and the specific action frames is not a limitation on the invention.

TABLE I

| | | Port Remains Available | |
|---|---|---|---|
| | Dialog Token | After Successful | Receive |
| | Generated by | Transmission For | Indicated |
| Action Frame | Driver | Receiving Replies | to OS |
| GO Negotiation | Yes | Yes | Yes |
| Request | | | |
| GO Negotiation | No | Yes if the response | Yes |
| Response | | indicates that the nego- | |
| | | tiations were successful, | |
| | | No Otherwise | |
| GO Negotiation | No | No | Yes |
| Confirmation | | | |
| P2P Invitation | Yes | Yes | Yes |
| Request | | | |
| P2P Invitation | No | No | Yes |
| Response | | | |
| Provision | Yes | Yes | Yes |
| Discovery | | | |
| Request | | | |
| Provision | No | No | Yes |
| Discovery | | | |
| Response | | | |

When the operating system 320 submits a request to a control port to send one of the action frames in Table I, functional module 394C within driver 344 may take actions such as:
a. Select a dialog token for the transmission. If the send is in response to a request, the operating system may provide the dialog token (as described below) to be used and driver 344 may then use the specified dialog token.
b. Complete the request. If driver 344 selected the dialog token, it may report the dialog token to the operating system 320 in the completion of the request.
c. Sync with the WI-FI Direct device to which the frame is targeted. Depending on the implementation, if the send is in response to a received request (e.g. Invitation Response sent on reception of an invitation request), this step may be omitted.
d. Send the frame & wait for an ACK.
e. Once the ACK for the frame is received or if none of the retry attempts get an ACK, send a NDIS_STATUS indication to operating system 320 to notify about the transmission status of the action frame. This indication may include the information elements from the packet containing the action frame.

If the send was for a frame that would receive a reply from the peer device and the transmission was successful, the port may remain available for the peer device to send reply action frames to the miniport. The timeout and mechanism of being available should follow the WI-FI Peer-To-Peer Technical Specification.

The specific component within operating system 320 that triggers functional module 394C to send action frames when functional module 394C is associated with a port is not critical to the invention. However, FIG. 3 illustrates a device manager 330 within operating system 320. Device manager 330, for example, may be a device manager as is known in the art that may present a user or programmatic interface through which a user or other executing component may request that a communication session be established with a device using peer-to-peer communication.

When a port, such as port 386, is configured to act as a controller for peer-to-peer communication by associating that port with functional module 394C, device manager 330 may interact with port 386 to control various aspects of establishing peer-to-peer communication with one or more devices. For example, device manager 330 may receive user input requesting that computing device 310 be wirelessly connected to a device such as printer 134 (FIG. 1). In response to such input, device manager 330 may interact through stack 322 with port 386, causing functional module 394C to control radio 354 to transmit action frames.

The transmitted action frames may be those associated with device or service discovery. Device manager 330 may specify the nature of those requests, such as whether functional module 394C should seek to discover any device in the vicinity of computing device 310 or only devices that provide an identified service, such as a printer service. Though, device manager 330 may be configured to send commands in other formats through port 386 to establish communication with one or more devices in a group.

As an example, FIG. 3 shows that operating system 320 maintains a persistent device store 328. Persistent device store 328 may contain information identifying devices with which computing device 310 has previously established wireless communication. Device manager 330 may access information in persistent device store 328 to identify specific devices and send commands through port 386 for functional module 394C to generate action frames to establish a wireless connection with a device identified in persistent device store 328 automatically, in response to user input or in response to any other suitable trigger.

In scenarios in which device manager 330 requires information, such as a password or identifier, to establish communication with an external device, device manager 330 may alternatively or additionally interact with a user through a user interface (not expressly shown in FIG. 3) to obtain that information from a user or some other source. When that acquired information needs to be transmitted, device manager 330 may interact with the port configured as a controller to cause that information to be sent.

Regardless of the mechanism that triggers a port configured as a control port, such as port 386, to identify a group of devices, the control port may send and receive action frames to identify one or more devices that form a group including computing device 310. The actions initiated through port 386, in addition to identifying the group, may negotiate a role for computing device 310 within that group. In the illustrated example of the WI-FI direct peer-to-peer protocol, a device may have a role in a group as the group owner or as a client. Communication with another device or devices in the identified group may be performed through a different port. That port may be configured to support behavior in the role identified for computing device 310.

In the example illustrated in FIG. 3, additional ports 388 and 390 are illustrated. Each of these ports may be associated with a different role. For example, port 388 may be associated with the role of group owner. Port 390 may be associated with the role of client. Configuring a port for a different role may be performed by associating the port with the functional module that performs operations associated with the role. For example, functional module 394D, which performs functions associated with a device operating as a group owner, may be associated with port 388. Likewise, functional module 394E which performs functions associated with the device operating as a client, may be associated with port 390.

In operation, as packets are received through radio 354 having MAC addresses associated with ports 388 or 390, multiplexer/demultiplexer 392 will route those packets for processing within the associated port. Packets routed to port 388 may be processed by functional module 394D, which may perform actions associated with the role of a group owner. Packets containing data frames may be processed by placing the data in memory and notifying stack 322 that data has been received. Such an interaction with operating system 320 may use stack signaling techniques as are known in the art. Though the specific mechanism by which communication between each port and operating system 320 occurs is not critical to the invention.

When management frames are sent as part of a session established with a group in which computing device 310 is the group owner, those management frames may likewise be routed by multiplexer/demultiplexer 392 to port 388. Functional module 394C may be configured to either respond to those management frames or may be configured to report the management frames to operating system 320 depending on whether functional module 394C is programmed to respond to them.

Similarly, if computing device 310 is configured for the role of a client in a group, packets relating to communication with devices in that group will be identified with a MAC address that causes multiplexer/demultiplexer 392 to route those packets to a port configured as a client, such as port 390. Port 390 may be associated with functional module 394E, implementing functionality of a client according to a peer-to-peer protocol. Functional module 394E may be configured to transfer data from data frames in such packets to memory and notify operating system 320 of that data, using techniques as are known in the art. Functional module 394E may respond to packets containing management frames or may notify operating system 320 of those management frames.

FIG. 3 illustrates a specific hierarchy of communication functions. Certain functions relating to communication with external devices are performed within radio 354. Other functions are performed within driver 344. Yet further functions are performed within operating system 320. Though not specifically illustrated, even further functions may be performed by applications 220 or by input from a user or source external to computing device 310. With such an architecture higher level functions, such as determining which devices to connect to as part of a peer-to-peer group, may be performed at higher levels in the architecture. Conversely, lower level functions, such as generating an acknowledgement to a received packet may be performed at lower levels in the architecture. For example, driver 344 may be configured to generate such an acknowledgement.

Though other architectures are possible that may partition the functions differently so that different aspects of communication are controlled by different components, in the example illustrated, radio 354 and driver 344 are configured to respond statelessly to events, such as commands or received packets. To the extent state information is involved in a communication session, that state information may be maintained within operating system 320. For example, stack 322 may maintain state information for communication sessions carried on through any of the ports 382, 384, 386, 388 and 390. The specific state information maintained may depend on the number and types of states within a protocol supported by each of the ports.

In the example of FIG. 3, session state information 324A is shown associated with port 388. Though not expressly illustrated, session state information may be maintained for other ports. Depending on the protocol implemented by port 388, such session state information may indicate parameters of a session, such as a number of devices that are joined in a group for which computing device 310 is the group owner. Other state information, such as a time until those devices may enter a lower power mode, may also be stored as part of the session state information 324.

FIG. 3 additionally shows session state information 324B and 324C associated with port 388. State information 324B and 324C may describe different sessions. Such sessions may arise if computing device 310 is joined in three groups in which it is the group owner. To support multiple such sessions, a mechanism may be provided to associate specific frames sent or received with a corresponding session. Any suitable identifier or identifiers may be used. For example, communications with a group of devices may be regarded as session, such that an identifier of a group may be used to group related communications as part of a session. Stack 322 provides an interface to device manager 330 or other components that associates each session with the appropriate component that is an end point in that session. Such interfacing may be performed using techniques as are known in the art.

In addition to maintaining state information that allows communications from separate sessions to be presented appropriately, stack 322 may maintain, as part of the state information maintained for each session, information that allows stack 322 to relate communications that are part of an exchange of communications to perform a function. For example, when a frame, representing a request, is sent, recognizing that a subsequently received frame is a response to that request may facilitate processing of the request and response. Providing a mechanism to relate communications that are part of an exchange may facilitate processing, particularly if multiple sessions are supported on the same port. To enable recognition of communications that are part of an exchange, “dialog tokens” may be used. A communication initiating an exchange may be tagged with such a dialog token. Upon responding to such a communication, the dialog token from the request may be copied to the response. Accordingly, a device sending a request may associate a response, or any other communication that is part of the same exchange, with the request. Accordingly, state information 324A may contain dialog tokens associated with ongoing communications involving any device communicating as part of the session.

Dialog tokens may be generated in any suitable way. They may, for example, be generated within the operating system 320. Alternatively, if a packet beginning a dialog is initiated in a port, the port or other component within driver 344 may generate the token. Similarly, if a reply to a packet is generated within a port, such as port 386, 388 or 390, the token may be inserted in the reply by that port. Conversely, if a reply to a packet is initiated in response to a command generated within operating system 320, a component within operating system 320, such as stack 322 may specify the token for inclusion in the reply. Table I indicates, for the listed action frames, whether the dialog token associated with an action frame is generated in the operating system or, if not, in the driver. Though, it should be appreciated that Table I represents only one example of how the functionality of generating a dialog token for a frame may be partitioned, any suitable partitioning of that function may be used.

Similar session state information 326A, 326B and 326C is shown in connection with port 390. Session state information 326A, 326B and 326C may represent state maintained for each of three sessions, with each session being associated with a group in which computing device 310 is a member with the role of client. As with session state information 324A, 324B and 324C a unique dialog token may be associated with each of the sessions, allowing stack 322 to separate received packets associated with each of the sessions. Likewise, computing device 310 may cause a dialog token to be associated with packets transmitted from computing device 310. The dialog tokens may be used to allow stack 322, or similar processing components on remote devices that receive packets from computing device 310, to associate packets that are part of a multi-packet exchange of information. For example, a second packet sent in reply to a first packet may include the token from the first packet. As a result, when the sender of the first packet receives the second packet, it can associate the first packet and second packet with the same dialog.

With the architecture illustrated in FIG. 3, state information concerning each of the connections may be maintained within operating system 320. As a result, the ports 386, 388 and 390 need not maintain state information. In some embodiments, functional modules, such as functional modules 394C, 394D and 394E, that implement the functions of a port do not maintain state information. Rather, each of the functional modules may be encoded to respond to events, such as a command from operating system 320 or a received packet passed on by radio 354. Though, regardless of how this functionality is partitioned, computing device 310 may be controlled to supply functionality associated with multiple entities by establishing and configuring a port to perform the functionality of each entity. As a result, computing device 310, because driver 344 and radio 354 may be configured to support multiple ports, may concurrently operate as different entities. These entities may include entities associated with infrastructure mode communication as well as entity associated with peer-to peer communication.

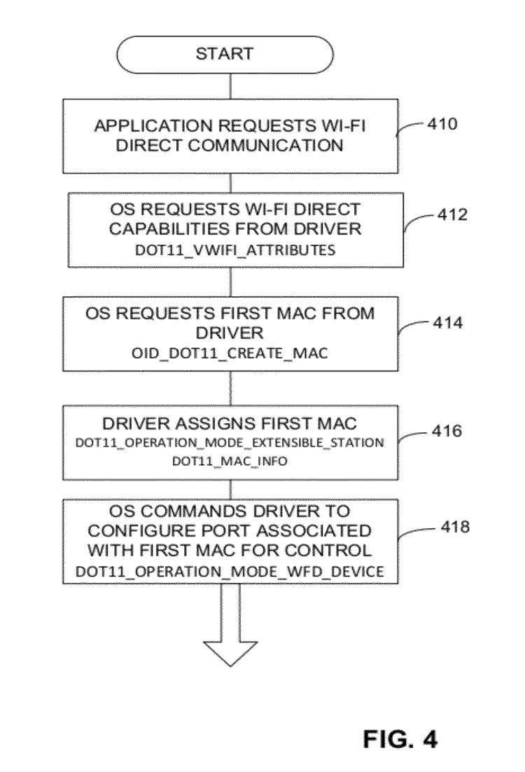

FIG. 4 illustrates a process by which computing device 310 may operate to establish communication according to a peer-to-peer protocol. The process of FIG. 4 begins at block 410 with an input indicating that peer-to-peer communication is to be performed. In this example, block 410 involves an application program requesting operating system 320 establish peer-to-peer communication. The request in this example is for peer-to-peer communication using the WI-FI direct standard. Such a request, for example, may be made by an application component, such as a word processor, requesting that device manager 330 (FIG. 3) identify a printer. Though, regardless of the reason for initiating peer-to-peer communication, processing at block 410 may entail an application placing a call on operating system 320.

Such a call may trigger the operating system 320 to configure driver 344 for peer-to-peer communication. Though, prior to attempting to configure driver 344, the operating system 320 may determine that the driver installed in computing device 310 is capable of being configured for peer-to-peer communication according to the WI-FI direct standard. Processing at block 412 may entail passing a command through interface 346. As one example, the command may be in the form of an OID called DOT11_VWIFI_ATTRIBUTES. Though, it should be appreciated that the specific form of the command is not critical to the invention.

Regardless of the form of the command, driver 344 may respond with an indication of its ability to support communications according to the WI-FI Direct protocol. In the example illustrated in FIG. 3 in which driver 344 can support multiple ports, some of which may be configured for WI-FI Direct communications, the response received at block 412 will indicate such capabilities of driver 344. Accordingly, the process of FIG. 4 may proceed. In embodiments in which the driver 344 is not capable of supporting WI-FI Direct communications, processing at block 412 may entail selecting an alternative communications mechanism or other suitable response.

In the scenario illustrated in which the driver does support communication according to the requested protocol, processing proceeds to block 414. At block 414, the operating system may request that the driver establish a port to be used for WI-FI Direct communication. As with other commands sent from operating system 320 to driver 344, such a request may be sent in the form of a command through interface 346. In this example, the command may be an OID in the form of OID_DOT11_CREATE_MAC. Though the specific format of the command is not critical to the invention.

In response to such a command, driver 344 may configure radio 354 to recognize an additional MAC address to be associated with the port requested for peer-to-peer communication. The MAC address may be obtained at any suitable way. For example, it may be hardwired in radio 354, generated by driver 344 or even provided by operating system 320, such as in conjunction with the command sent at block 414.

Regardless of the manner in which the MAC address is generated, once it is established, driver 344 may respond to operating system 320 with information on the port established using that MAC. The response may be in the form of a status message sent through interface 346. As one example, the status message may be in the form of an OID called DOT11_MAC_INFO. In conjunction with this status message, driver 344 may specify an interface address. The interface address will identify for operating system 320 information necessary to access the port that driver 344 has created. The interface address in this scenario need not be related to the MAC address used by radio 354. Rather, multiplexer/demultiplexer 392 (FIG. 3) will complete a mapping between the MAC address associated with the port and the interface address through which operating system 320 may access the port.

In the embodiment described in connection with FIG. 3 in which ports perform specific functions, once a port is created, it is configured by associating that port with a specific set of functions. For establishing peer-to-peer communication, ultimately a port configured as either a group owner or a client may be used. However, before a port for a specific role for a device while communicating data with other devices in a group can be determined, multiple action frames may be exchanged with other devices in the vicinity of computing device 310 to form that group and negotiate a specific role for computing device 310 in that group. In the embodiment illustrated in FIG. 3, those control frames are exchanged through a control port, such as support 386 that becomes associated with a functional module 394C to perform control functions. Accordingly, at block 418, the process may entail operating system 320 sending a command to driver 344 to configure the port defined at block 416 as a control port. Such a command may be sent through interface 346. As an example, the command may be in the form of an OID called DOT11_OPERATION_MODE_WFD_DEVICE.

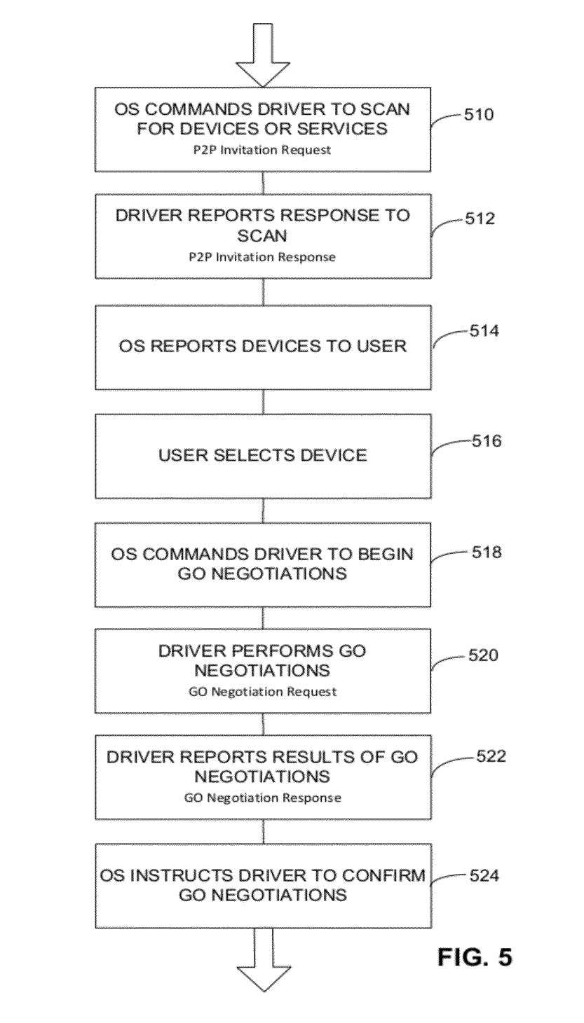

Once the control port is established, the process may proceed to FIG. 5, which illustrates operations performed through that control port to establish a group of devices including computing device 310. Processing in FIG. 5 begins at block 510 with the operating system 320 sending a command to driver 344 to scan for devices or services. The command may be sent through the interface address established for the control port at block 416 (FIG. 4).

In response to such a command, at block 512, driver 344 may control radio 354 to transmit one or more packets containing action frames, requesting devices receiving the packets to respond. The transmitted packets may be tagged with a dialog token and a MAC address associated with port 386 acting as the control port. Accordingly, any responses detected by radio 354 will be passed through multiplexer/demultiplexer 392 to port 386. From port 386, the responses may be passed to operating system 320, still tagged with the dialog token such that they can be identified as responses to the scan.

The responses passed to operating system 320 may contain information identifying devices in the vicinity of computing device 310 available for wireless communication as part of a peer-to-peer group. At block 514, operating system 320 may use information in the responses to request user input on whether a wireless connection should be established with any of the devices that responded. Such a request may be made in any suitable way, including presenting through a user interface one or more options of devices with which computing device 310 may connect. At block 516, a user may provide input selecting a device or multiple devices. Though, the specific processing used to identify a device with which to form a connection is not critical to the invention.

Regardless of the manner in which a device with which to form a connection is identified, the process may proceed to block 518 where the operating system may issue a command to driver 344 to begin negotiating a group with the identified devices. A portion of the process of forming a group in the WI-FI Direct protocol is group owner negotiation. Accordingly, at block 518, the operating system 320 may command driver 344 to begin group owner negotiations. Such a command may be sent through the interface address allocated for the control port.

At block 520, driver 344 may control radio 354 to transmit packets containing action frames that are part of group owner negotiations. These packets may be formatted in accordance with WI-FI Direct protocol. Though, similar actions may occur when other protocols are used.

In response to the action frame transmitted at block 520, one or more action frames may be received from devices external to computing device 310 that are in the vicinity of computing device 310. These responses may be processed within port 386, configured in this example to be a control port. In an embodiment in which the driver does not retain state-information, the processing may entail simply passing on responses to operating system 320. Though, in other embodiments, processing within port 386 alternatively or additionally may entail determining a response and controlling radio 354 to send it.

In the illustrative embodiment, based on the responses, the operating system may command driver 344 to send further action frames associated with group owner negotiation. Accordingly, it should be appreciated the processing at blocks 520 and 522 may be iteratively performed, with operating system 320 triggering driver 344 to send packets containing action frames. Driver 344 may pass those responses to operating system 320. Though, other embodiments are possible in which driver 344 identifies and sends without an express command from operating system 320 further action frames when it receives a response to a prior action frame.

The process of sending packets containing action frames, receiving responses and taking further actions based on those responses may continue until group owner negotiations conclude. The specific conclusion of group owner negotiations may depend on the protocol for wireless communications being implemented. In the embodiment illustrated in FIG. 5, though, the group owner negotiations conclude with computing device 310 sending to other devices in the group a group owner confirmation action frame. That action may be performed at block 524. Such an action may be triggered by operating system 320 commanding driver 344 through port 386 to send such an action frame.

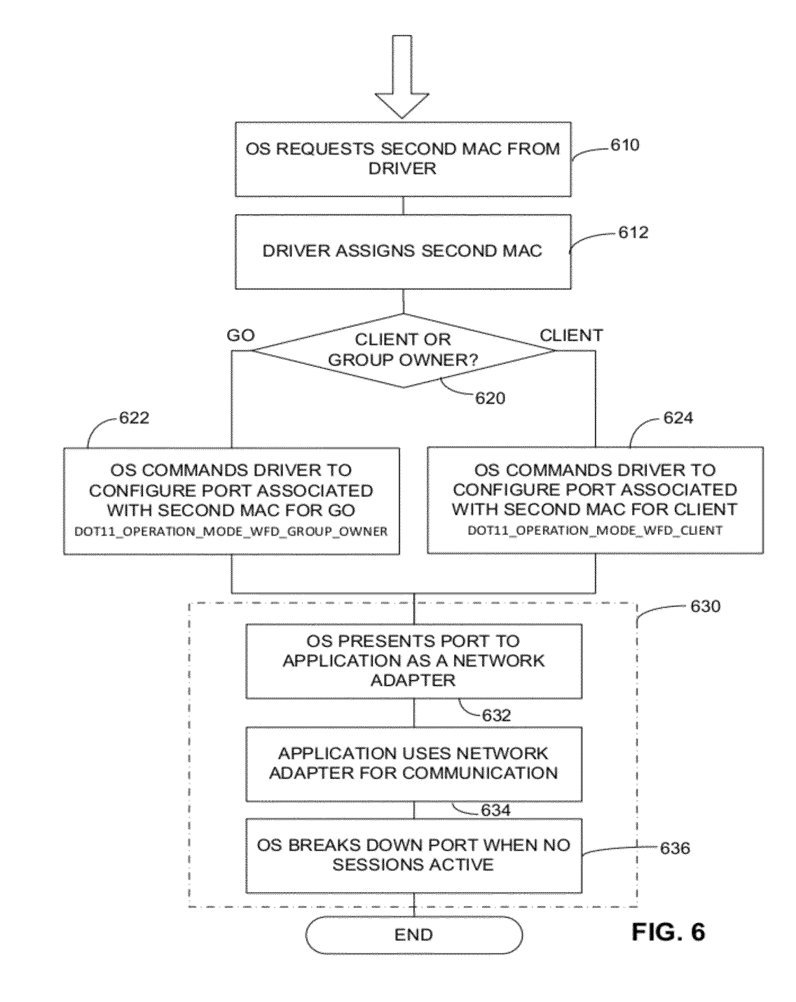

In the embodiment illustrated in which each port performs a specific function, a port used for establishing a group and negotiating a group owner does not process communications when computing device 310 is acting as a group owner or client in a peer-to-peer group. Rather, in the embodiment illustrated, at least one additional port may be used for this purpose. Accordingly, once negotiations of a group and a role for computing device 310 within that group are concluded, the process may proceed to block 610 (FIG. 6) where a second port is established to support connections with the devices in the formed group.

At block 610, the process of establishing such a port may begin with operating system 320 requesting that driver 344 establish a second port. Processing at block 610 may be the same at block 414. The response by the driver at block 612 may also be the same as the response at block 416, providing, for example, an interface address for the port.

Conversely, if the second port is to be used for communication in a group in which computing device 310 has the role of a client, processing may branch to block 624. At block 624, operating system 320 may command driver 344 to configure the second port to perform functions associated with a client. As with the command at block 622, the command at block 624 may be passed through interface 346. In response to such a command, driver 344 may associate functional module 394E, containing the functionality of a client, with the second port created at block 612.

Regardless of the specific role for which the second port is to be configured, once that configuration is completed, processing may proceed to subprocess 630. Within subprocess 630, operating system 320 may treat the port as an interface to a radio configured for a specific role. Such an interface may be presented to application components as a network adapter using the specified interface address for the port. Each port created may be presented as a separate network adapter. Formatting of interfaces to network adapters is known in the art, and operating system 320 may use such known formatting to present each port as a network adapter. Though, it should be appreciated that the specific format in which the port is presented by the operating system at block 632 is not critical to the invention.

Regardless of the format in which the port is presented, an application may then use the port to exchange information wirelessly. At block 634, the application may interact with the network adapter for wireless communication using techniques as are known in the art. Such exchanges at block 634 may continue until the application terminates or otherwise has no further need for communication through that port. While the port exists, other application on components may also exchange information through it.

Accordingly, at block 636, when the operating system detects that no communication sessions through a port are active, the operating system may send a command to break down the port. As an example, Table I indicates whether a control port is to remain active after certain action frames are transmitted. Similar operating patterns may be defined for other ports and such information may be used to determine whether a command is sent to break down a port.

If a port is to be broken down, a command may be sent through interface 346. In response, driver 344 may delete data structures created upon establishing the port and may command radio 354 to change its configuration, such that radio 354 no longer responds to the MAC address associated with that port. Breaking down a port at block 636 allows the MAC address to be reused for a different port. Such a capability may be useful, for example, in embodiments in which driver 344 can be configured for more types of ports than radio 354 supports MAC addresses. In this way, MAC addresses may be shared among ports of different types over time.

Though, an alternative to breaking down a port may be to use it for a different function. In some embodiments, a control port may be maintained for so long as any peer-to-peer wireless session is active. In that scenario, a single session may have two ports, a control port and a communication port, configured either for communication as a group owner or a client. In some scenarios, the control port, because it is predominantly used in establishing the group for peer-to-peer communication, may support other functions during the session in which data is being communicated through an associated communication port. As a specific example, once a group of wireless devices is established, the control port may be used as a “side channel.” A side channel may be used to transmit control information unrelated to the protocol for wireless communication.

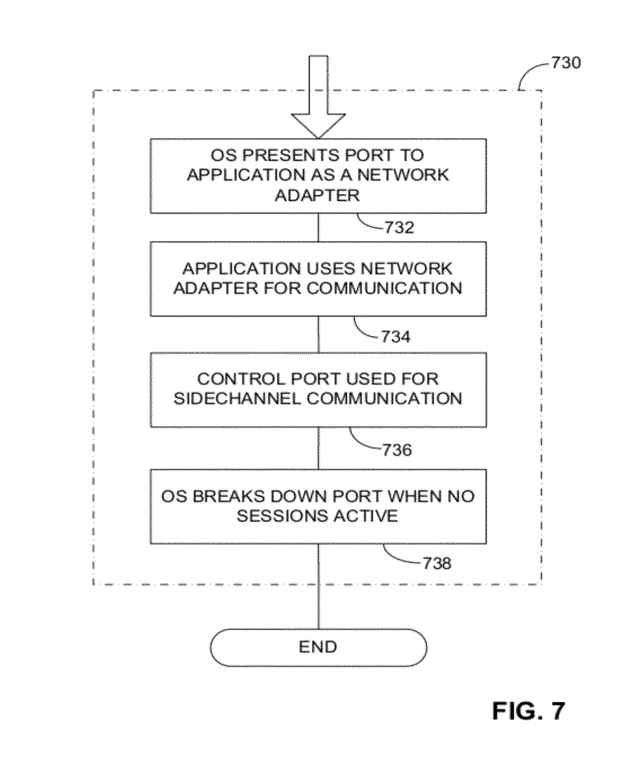

FIG. 7 illustrates a subprocess 730 that may be an alternative to subprocess 630. As illustrated, subprocess 730 may begin similarly to subprocess 630. At block 732, the operating system 320 may present a communications port, configured for a specific role in a peer-to-peer group, to applications through a network adapter. At block 734, the applications may use that network adapter for communication. Specifically, the communication may entail exchanging data with an external device that is part of a group of which computing device 310 is a member.

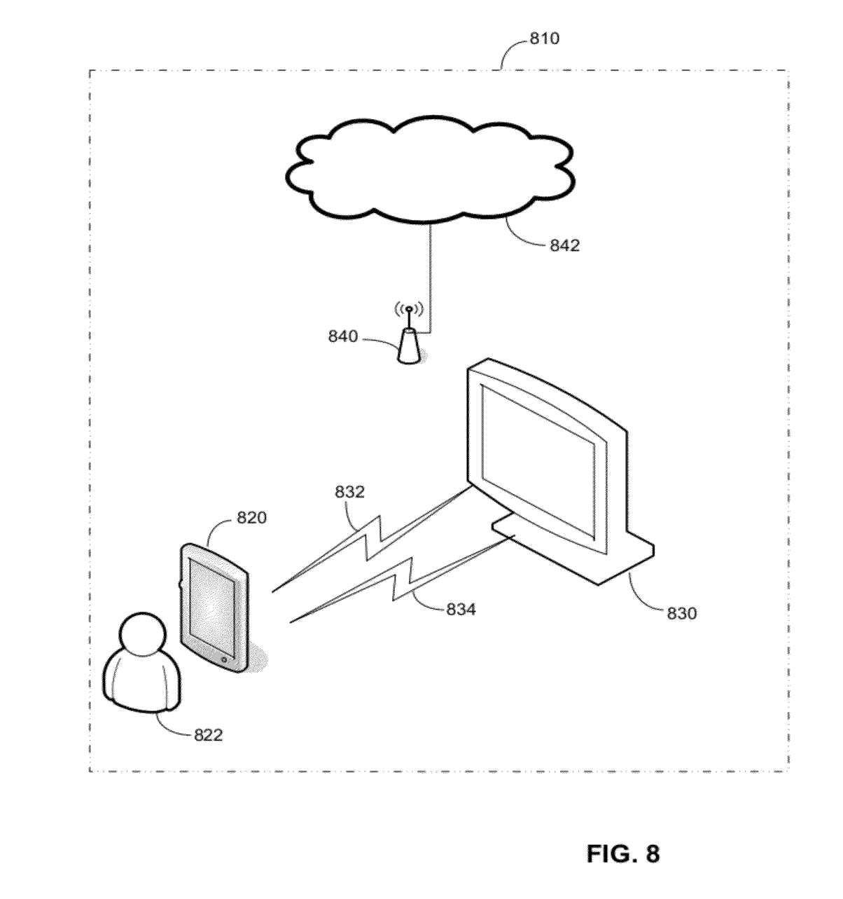

At block 736, concurrently with transmitting data, for example, the control port used in establishing the group may be used for side channel communications. In the embodiment of FIG. 3, such a capability may be implemented by encoding functional module 394C, which implements the functions of a control port, to respond to a command to send side channel information. Though this command, and in some instances the data to send, is provided through the control port, it may be sent in a way that is separate from action frames used to establish a wireless group. Processing at block 736 may also be performed in response to an application component accessing the control port to provide those commands. The specific format of a command or commands to trigger side channel communication, and the nature of the information transmitted, is not critical to the invention. However, FIG. 8 illustrates an example environment 810 in which a control port may be used for side channel communication.

FIG. 8 illustrates a wireless computing device 820, which may be configured similarly to computing device 310 (FIG. 3) for wireless communication according to a peer-to-peer protocol, such as the WI-FI Direct protocol. In this environment, computing device 820 may be configured for the role of group owner in a group involving a display device, such as television 830. In this scenario, television 830 is configured to receive and display audio/video content sent to it over a wireless connection 832. For wireless connection 832, computing device 820 is configured as a group owner and television 830 is configured as a wireless client.

Computing device 820 may be configured with an application that allows a user 822 to select through a user interface associated with computing device 820, audio/video content to display on computing device 830. Such an application may control computing device 820 to establish a control port, through which a group containing computing device 820 and television 830 may be formed. Through that control port, computing device 820 and television 830 may negotiate a role for each device, such that computing device 820 is configured as a group owner and television 830 is configured as a client. In configuring computing device 820 as a group owner, a further communication port may be established for that role.

Nonetheless, the control port through which the group was negotiated may remain active. In this scenario, that port may be used to, from time to time, transmit a command that controls a display function of television 830. For example, even though audio/video content is streaming over wireless connection 832, user 822 may desire to send additional information to television 830 controlling the presentation of that information. That information, for example, may represent a command to adjust the volume with which television 830 presents the visual portion of the information. As another example, information sent using the control port for side channel communications may represent commands to television 830 to adjust the brightness or other aspects of the presentation of the visual portion of the information. In this way, computing device 820 may communicate commands to television 830, without requiring a further port to be established to support that communication.

In the example illustrated in FIG. 8, reusing a control port for side channel communication may allow computing device 820 to establish further wireless connections. For example, a MAC address may be available within computing device 820 to establish a port for wireless communications in an infrastructure mode. As a specific example, environment 810 includes an access point 840 through which computing device 820 may obtain access to network 842. With the architecture illustrated in FIG. 3, if a further port is available within computing device 820, that port may be used to establish a wireless connection between computing device 820 and access point 840 such that computing device 820 may communicate in infrastructure mode as well as in a peer-to-peer mode. In scenarios in which computing device 820 is limited by the number of ports it can support, if a further port were required to convey audio/video control information to television 830, a port may not be available for a wireless connection to access point 840. Accordingly, by using the control port to also convey audio/video control information as side channel information, the capabilities for wireless communication of computing device 820 may be expanded.

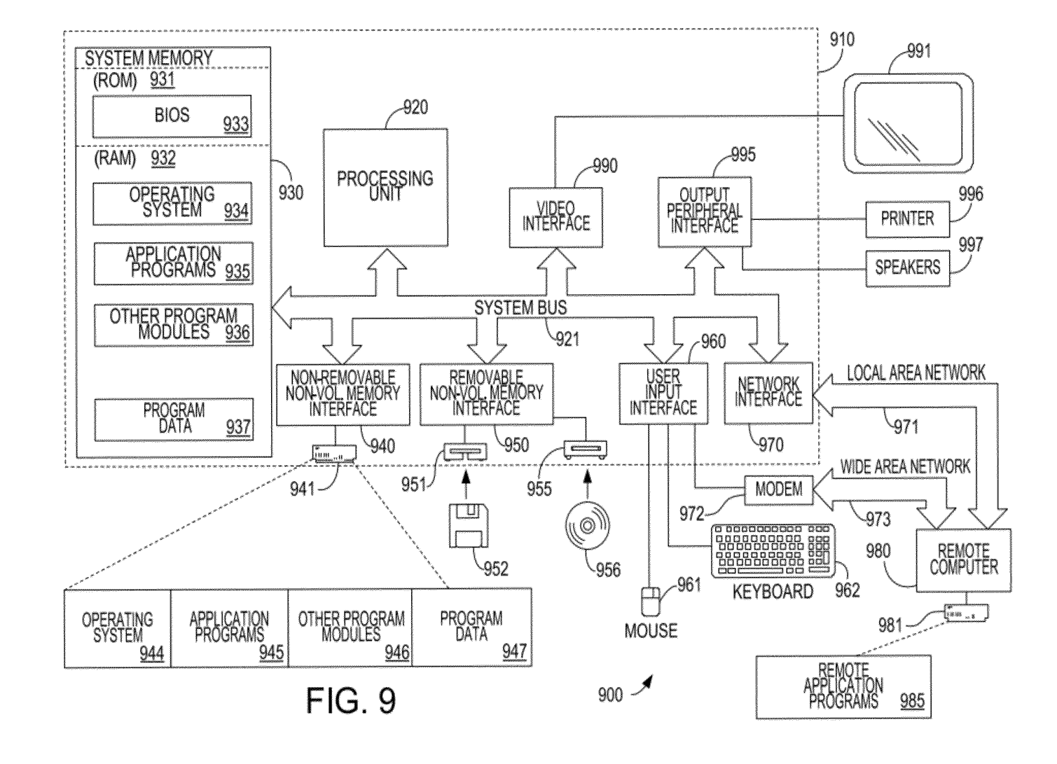

Any suitable computing device may be configured for wireless communication using techniques as described herein. FIG. 9 illustrates an example of a suitable computing system environment 900 on which the invention may be implemented. The computing system environment 900 is only one example of a suitable computing environment and is not intended to suggest any limitation as to the scope of use or functionality of the invention. Neither should the computing environment 900 be interpreted as having any dependency or requirement relating to any one or combination of components illustrated in the exemplary operating environment 900.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 9, an exemplary system for implementing the invention includes a general purpose computing device in the form of a computer 910. Components of computer 910 may include, but are not limited to, a processing unit 920, a system memory 930, and a system bus 921 that couples various system components including the system memory to the processing unit 920. The system bus 921 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 910 typically includes a variety of computer readable media. Computer readable media can be any available media that can be accessed by computer 910 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 910. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 930 includes computer storage media in the form of volatile and/or nonvolatile memory such as read only memory (ROM) 931 and random access memory (RAM) 932. A basic input/output system 933 (BIOS), containing the basic routines that help to transfer information between elements within computer 910, such as during start-up, is typically stored in ROM 931. RAM 932 typically contains data and/or program modules that are immediately accessible to and/or presently being operated on by processing unit 920. By way of example, and not limitation, FIG. 9 illustrates operating system 934, application programs 935, other program modules 936, and program data 937.

The computer 910 may also include other removable/non-removable, volatile/nonvolatile computer storage media. By way of example only, FIG. 9 illustrates a hard disk drive 940 that reads from or writes to non-removable, nonvolatile magnetic media, a magnetic disk drive 951 that reads from or writes to a removable, nonvolatile magnetic disk 952, and an optical disk drive 955 that reads from or writes to a removable, nonvolatile optical disk 956 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 941 is typically connected to the system bus 921 through a non-removable memory interface such as interface 940, and magnetic disk drive 951 and optical disk drive 955 are typically connected to the system bus 921 by a removable memory interface, such as interface 950.

The drives and their associated computer storage media discussed above and illustrated in FIG. 9, provide storage of computer readable instructions, data structures, program modules and other data for the computer 910. In FIG. 9, for example, hard disk drive 941 is illustrated as storing operating system 944, application programs 945, other program modules 946, and program data 947. Note that these components can either be the same as or different from operating system 934, application programs 935, other program modules 936, and program data 937. Operating system 944, application programs 945, other program modules 946, and program data 947 are given different numbers here to illustrate that, at a minimum, they are different copies. A user may enter commands and information into the computer 910 through input devices such as a keyboard 962 and pointing device 961, commonly referred to as a mouse, trackball or touch pad. Other input devices (not shown) may include a microphone, joystick, game pad, satellite dish, scanner, or the like. These and other input devices are often connected to the processing unit 920 through a user input interface 960 that is coupled to the system bus, but may be connected by other interface and bus structures, such as a parallel port, game port or a universal serial bus (USB). A monitor 991 or other type of display device is also connected to the system bus 921 via an interface, such as a video interface 990. In addition to the monitor, computers may also include other peripheral output devices such as speakers 997 and printer 996, which may be connected through an output peripheral interface 995.

The computer 910 may operate in a networked environment using logical connections to one or more remote computers, such as a remote computer 980. The remote computer 980 may be a personal computer, a server, a router, a network PC, a peer device or other common network node, and typically includes many or all of the elements described above relative to the computer 910, although only a memory storage device 981 has been illustrated in FIG. 9. The logical connections depicted in FIG. 9 include a local area network (LAN) 971 and a wide area network (WAN) 973, but may also include other networks. Such networking environments are commonplace in offices, enterprise-wide computer networks, intranets and the Internet.

When used in a LAN networking environment, the computer 910 is connected to the LAN 971 through a network interface or adapter 970. When used in a WAN networking environment, the computer 910 typically includes a modem 972 or other means for establishing communications over the WAN 973, such as the Internet. The modem 972, which may be internal or external, may be connected to the system bus 921 via the user input interface 960, or other appropriate mechanism. In a networked environment, program modules depicted relative to the computer 910, or portions thereof, may be stored in the remote memory storage device. By way of example, and not limitation, FIG. 9 illustrates remote application programs 985 as residing on memory device 981. It will be appreciated that the network connections shown are exemplary and other means of establishing a communications link between the computers may be used.

Having thus described several aspects of at least one embodiment of this invention, it is to be appreciated that various alterations, modifications, and improvements will readily occur to those skilled in the art.

As one example, communications are described from the perspective of a single computing device. It should be appreciated that the computing device is communicating with external devices, some of which may also be computing devices, that can similarly be operated for wireless communication. Those external devices may use the architecture described above.

As another example, FIG. 3 illustrates an embodiment in which a driver interacts with a single radio to transmit and receive all communications with multiple infrastructure-mode sessions and peer-to-peer sessions. In other embodiments, multiple radios may be used. Even if multiple radios are used, a single driver may be used to control those drivers. Such a driver may route and sequence communications as with a driver for a single radio. Though, a single driver is not a requirement of the invention.

As yet another example, FIGS. 4-6 illustrate a process in which a computing device initiates formation of a peer-to-peer group. Other scenarios are possible in which the specific sequence of steps or specific steps performed may differ. For example, rather than initiating the formation of a group, the computing device may receive a request to join a group or to respond to a device or service discovery request. However, the port structure as described above alternatively or additionally may support those alternative communication sequences.

Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other non-transitory, tangible computer storage medium) encoded with one or more programs that, when executed on one or more computers or other processors, perform methods that implement the various embodiments of the invention discussed above. The computer readable storage medium or media can be transportable, such that the program or programs stored thereon can be loaded onto one or more different computers or other processors to implement various aspects of the present invention as discussed above. As used herein, the term “non-transitory computer-readable storage medium” encompasses only a computer-readable medium that can be considered to be a manufacture (i.e., article of manufacture) or a machine. Alternatively or additionally, the invention may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A computing device (310), comprising:
a radio (354) for wireless communication;
a driver (344) for controlling the radio to implement a plurality of ports (382, 284, 386, 388, 390), the plurality of ports comprising:
at least one port for operation in an infrastructure mode (382, 384);
a control port for controlling a peer-to-peer connection (386); and
at least one peer-to-peer communication port (388, 390); and
an operating system (320) configured to interact with the driver for establishing a peer-to-peer connection using the control port and to communicate over the peer-to-peer connection through the peer-to-peer communication port.

2. The computing device of claim 1, wherein the operating system is further configured for sending commands through the control port to control audio/visual characteristics (736) of a display device (830) coupled to the computing device over the peer-to-peer connection (832).

3. The computing device of claim 1, wherein:
the driver implements the control port by associating a Media Access Control (MAC) address (356A . . . 356E) with the control port and controlling the radio to transmit control frames associated with the MAC address of the control port.

4. The computing device of claim 3, wherein:
the control frames comprise public action frames and service discovery frames.

5. The computing device of claim 4, wherein:
the operating system interacts with the driver to establish a peer-to-peer connection by sending a command to the driver to create the peer-to-peer communication port (610).

6. The computing device of claim 5, wherein:
the operating system interacts with the driver to establish a peer-to-peer connection by sending a command to the driver to configure the peer-to-peer communication port for an operational role in the peer-to-peer communication.

7. The computing device of claim 6, wherein:
the operating system sends a command to the driver to configure the peer-to-peer communication port for an operational role in the peer-to-peer communication by specifying a role comprising one of a group owner or a client.

8. The computing device of claim 7, wherein:
the at least one peer-to-peer communication port is configured for operation in accordance with a WI-FI Direct protocol; and
the at least one port operating in infrastructure mode is configured for operation in accordance with a WI-FI infrastructure-mode protocol; and
the control port is configured for operation at a lower bit rate than each of the at least one peer-to-peer communication ports.

9. The computing device of claim 1, wherein the operating system is further configured for sending commands through the control port to identify the number of peer-to-peer communication ports.

10. The computing device of claim 1, wherein the operating system is further configured for sending commands through the control port to identify role of peer-to-peer communication ports whether Group Owner or Client.

11. A method of operating a computing device (310) having a wireless radio (354) controlled by a driver (344), the method comprising:
with at least one processor:
providing a command to the driver to supply a control port for establishing wireless communication using a peer-to-peer protocol (414);
sending through the control port at least one command for the driver to control the wireless radio to send an action frame (510, 518, 524);
receiving through the control port a reply to one or more of the at least one commands for the driver to control the wireless radio to send an action frame (512, 522);
based on the reply to the one or more of the at last one commands, determining to establish a wireless connection with at least one remote device and a role for the computing device in the wireless connection (522);
providing at least one command to the driver to supply a communication port and to configure the communication port for the determined role of the computing device in the wireless connection (622,624); and
exchanging data packets with the at least one remote device through the communication port (634).

12. The method of claim 11, wherein:
the remote device comprises a display device (830);
the data packets comprise audio/video content; and
the method further comprises sending through the control port commands to control at least one audio/visual characteristic of presentation of the audio/visual context on the display device (736).

13. The method of claim 11, wherein:
determining the role for the computing device comprises selecting a role as a group owner or a client (620).

14. The method of claim 12, wherein:
the wireless connection comprises a first wireless connection;
the method further comprises:
interacting with the driver through a station port, the interaction comprising forming a second wireless connection, the second wireless connection being with an access point (840), wherein communication is conducted concurrently over the first wireless connection and the second wireless connection.

15. The method of claim 12, wherein:
the wireless connection comprises a first wireless connection; and
the method further comprises:
interacting with the driver through the control port to establish a second wireless connection with a set of remote devices and determine a role for the computing device in the second wireless connection;
providing at least one command to the driver to supply a second communication port and to configure the communication port for the determined role of the computing device in the second wireless connection; and
exchanging data packets with the second set of remote devices through the second communication port.

16. The method of claim 15, wherein:
exchanging data packets with the second set of remote devices occurs concurrently with exchanging data packets with the at least one remote device.

17. At least one computer-readable storage medium comprising computer-executable instructions that, when executed, implement a driver for controlling a wireless radio, the driver comprising an operating system interface, and the computer-executable instructions of the driver for:
receiving through the interface a request to establish wireless communication in accordance with a peer-to-peer communication protocol;
associating a first MAC address with a control port for the communication in accordance with a peer-to-peer communication protocol;
receiving through the interface one or more requests related to forming a group;
in response to the one or more requests related to forming a group:
controlling the wireless radio to transmit control frames; and
reporting responses to the control frames through the interface, the
responses being associated with the control port;
receiving through the interface, a request to establish a second port for communication in accordance with the peer-to-peer communication protocol;
associating a second MAC address with the second port;
receiving through the interface data packets for communication in accordance with the peer-to-peer communication protocol, the data packets being received in association with the second port; and
providing through the interface data packets received from the wireless radio and having the second MAC address, the data packets being provided with an association with the second port;

18. The computer-readable storage medium of claim 17, wherein the computer-executable instructions of the driver are further for:
receiving through the interface a request to configure the second port for communication in accordance with any one of at least two roles within a communication session.

19. The computer-readable storage medium of claim 18, wherein the at least two roles comprise a group owner and a client.

20. The computer-readable storage medium of claim 17, wherein:
the computer-executable instructions of the driver are further for establishing at least one third port for communication in accordance with an infrastructure communication protocol; and
the third port and the second port operate concurrently to support concurrent connections to an infrastructure network and a peer-to-peer group using the same wireless radio.
